(19) United States
(12) Patent Application Publication
(10) Pub. No.: US 2025/0147815 A1
(43) Pub. Date: May 8, 2025

(54) MANAGED CLOUD OFFERING FOR SENSITIVE INDUSTRY VERTICALS

(71) Applicant: Google LLC, Mountain View, CA (US)

(72) Inventors: Gopala Suryanarayana, Cupertino, CA (US); Diwakar Gupta, Seattle, WA (US); Naoshad Mehta, Mountain View, CA (US); Zoltan Kalmanovich, Brooklyn, NY (US); James Michael Chacon, Duvall, WA (US); Benoit Lefebvre, Campbell, CA (US)

(73) Assignee: Google LLC, Mountain View, CA (US)

(21) Appl. No.: 18/501,297

(22) Filed: Nov. 3, 2023

(51) Int. Cl. G06F 9/50

(52) U.S. Cl. CPC G06F 9/5072; G06F 2209/505

(57) ABSTRACT

A method includes obtaining, for each service of a plurality of services of a public cloud environment, a criticality classification. Each criticality classification includes one of a critical classification, a semi-critical classification, or a non-critical classification. The method includes obtaining a maintenance schedule for the public cloud environment. The maintenance schedule includes a plurality of maintenance windows and each maintenance window of the plurality of maintenance windows is associated with a respective criticality classification. The method includes receiving a maintenance request requesting maintenance of one of the plurality of services. The method also includes determining that each maintenance window associated with the respective criticality classification of the one of the plurality of services is currently closed. In response to determining that each maintenance window associated with the respective criticality classification of the one of the plurality of services is currently closed, the method includes denying the maintenance request.

### TECHNICAL FIELD

This disclosure relates to managed cloud offerings for sensitive industry verticals.

### BACKGROUND

Enterprises in verticals such as telecommunications, healthcare, energy, and financial services frequently are subject to strict regulations on how their businesses are operated. To abide by these regulations, these industries have established processes and operations around workload deployment and execution. Typically, there is a very high emphasis placed on infrastructure availability in these verticals, as any type of unavailability leads to a significant business impact including loss of revenue and reputation. Accordingly, these enterprises typically deploy their applications across multiple zones within the same region to ensure there are multiple failure domains which share non-correlated failure characteristics to offer high availability to their applications.

### SUMMARY

One aspect of the disclosure provides a method for a managed cloud offering for sensitive industry verticals. The computer-implemented method, when executed by data processing hardware, causes the data processing hardware to perform operations. The operations include obtaining, for each service of a plurality of services of a public cloud environment, a criticality classification. Each criticality classification includes one of a critical classification, a semi-critical classification, or a non-critical classification. The operations include obtaining a maintenance schedule for the public cloud environment. The maintenance schedule includes a plurality of maintenance windows and each maintenance window of the plurality of maintenance windows is associated with a respective criticality classification. The operations include receiving a maintenance request requesting maintenance of one of the plurality of services. The operations also include determining that each maintenance window associated with the respective criticality classification of the one of the plurality of services is currently closed. In response to determining that each maintenance window associated with the respective criticality classification of the one of the plurality of services is currently closed, the operations include denying the maintenance request.

Implementations of the disclosure may include one or more of the following optional features. In some implementations, the operations further include receiving a second maintenance request requesting maintenance of the one of the plurality of services, determining that one maintenance window associated with the respective criticality classification of the one of the plurality of services is currently open, and, in response to determining that the one maintenance window associated with the respective criticality classification of the one of the plurality of services is currently open, allowing the maintenance request. In some of these implementations, the operations further include determining that maintenance defined by the maintenance request will complete prior to the one maintenance window associated with the respective criticality classification of the one of the plurality of services closes and allowing the maintenance request is further in response to determining that the maintenance defined by the maintenance request will complete prior to the one maintenance window associated with the respective criticality classification of the one of the plurality of services closes.

In some examples, the public cloud environment includes a first cluster and a second cluster and the plurality of services execute within the first cluster or the second cluster. In some of these examples, the first cluster is associated with a first geographic region, the second cluster is associated with a second geographic region, and the first geographic region and the second geographic region are different. In other of these examples, when a first maintenance window of the plurality of maintenance windows is open for the plurality of services executing on the first cluster, each maintenance window of the plurality of maintenance windows is closed for services executing on the second cluster. Optionally, when a second maintenance window of the plurality of maintenance windows is open for the plurality of services executing on the second cluster, each maintenance window of the plurality of maintenance windows is closed for services executing on the first cluster. In some of these examples, the plurality of maintenance windows alternates opening and closing between the first cluster and the second cluster.

In some implementations, any maintenance window associated with the non-critical classification is always open. The maintenance schedule may include a recurring maintenance schedule with a predefined period.

Another aspect of the disclosure provides a system for a managed cloud offering for sensitive industry verticals. The system includes data processing hardware and memory hardware in communication with the data processing hardware. The memory hardware stores instructions that when executed on the data processing hardware cause the data processing hardware to perform operations. The operations include obtaining, for each service of a plurality of services of a public cloud environment, a criticality classification. Each criticality classification includes one of a critical classification, a semi-critical classification, or a non-critical classification. The operations include obtaining a maintenance schedule for the public cloud environment. The maintenance schedule includes a plurality of maintenance windows and each maintenance window of the plurality of maintenance windows is associated with a respective criticality classification. The operations include receiving a maintenance request requesting maintenance of one of the plurality of services. The operations also include determining that each maintenance window associated with the respective criticality classification of the one of the plurality of services is currently closed. In response to determining that each maintenance window associated with the respective criticality classification of the one of the plurality of services is currently closed, the operations include denying the maintenance request.

This aspect may include one or more of the following optional features. In some implementations, the operations further include receiving a second maintenance request requesting maintenance of the one of the plurality of services, determining that one maintenance window associated with the respective criticality classification of the one of the plurality of services is currently open, and, in response to determining that the one maintenance window associated with the respective criticality classification of the one of the plurality of services is currently open, allowing the maintenance request. In some of these implementations, the operations further include determining that maintenance defined by the maintenance request will complete prior to the one maintenance window associated with the respective criticality classification of the one of the plurality of services closes and allowing the maintenance request is further in response to determining that the maintenance defined by the maintenance request will complete prior to the one maintenance window associated with the respective criticality classification of the one of the plurality of services closes.

In some examples, the public cloud environment includes a first cluster and a second cluster and the plurality of services execute within the first cluster or the second cluster. In some of these examples, the first cluster is associated with a first geographic region, the second cluster is associated with a second geographic region, and the first geographic region and the second geographic region are different. In other of these examples, when a first maintenance window of the plurality of maintenance windows is open for the plurality of services executing on the first cluster, each maintenance window of the plurality of maintenance windows is closed for services executing on the second cluster. Optionally, when a second maintenance window of the plurality of maintenance windows is open for the plurality of services executing on the second cluster, each maintenance window of the plurality of maintenance windows is closed for services executing on the first cluster. In some of these examples, the plurality of maintenance windows alternates opening and closing between the first cluster and the second cluster.

In some implementations, any maintenance window associated with the non-critical classification is always open. The maintenance schedule may include a recurring maintenance schedule with a predefined period.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for a managed cloud offering for sensitive industry verticals.

FIG. 2 is a schematic view of an exemplary maintenance schedule for the system of FIG. 1.

FIG. 3 is a schematic view of exemplary clusters for different zones of the system of FIG. 1.

FIG. 4 is a schematic view of maintenance schedules for the different zones of FIG. 3.

FIG. 5 is a flowchart of an example arrangement of operations for a method for a managed cloud offering for sensitive industry verticals.

FIG. 6 is a schematic view of an example computing device that may be used to implement the systems and methods described herein.

Like reference symbols in the various drawings indicate like elements.

### DETAILED DESCRIPTION

Verticals such as telecommunications, artificial intelligence/machine learning, healthcare, energy, and financial services often have stringent requirements for deploying and managing workloads. Most of the customers in these verticals own and operate their workloads on-premises to meet the strict availability, compliance and maintenance requirements. However, there is a strong desire among such entities to move workloads to the public cloud in order to gain technology, cost and operational benefits at scale that the public cloud offers, while simultaneously maintaining a similar level of control over availability, compliance and maintenance requirements currently available on their premises. Meeting these requirements in a public cloud setting while still providing the pay-as-you-go and scale-as-you-go benefits of a public cloud are not currently supported by the deployment and management capabilities of conventional public cloud offerings.

More specifically, enterprises in these verticals are subject to strict regulations on how their businesses are operated. To abide by these regulations, these industries have established processes and operations around workload deployment and execution. Typically, there is a very high emphasis placed on infrastructure availability in these verticals, as any type of unavailability leads to a significant business impact including loss of revenue and reputation.

Accordingly, implementations herein include a service maintenance system that allows clients or entities to deploy their applications across multiple zones within the same region to ensure there are multiple failure domains which share non-correlated failure characteristics to offer high availability to their applications. Given the criticality of these applications, the implementations provide a robust disaster recovery (DR) strategy to ensure that workloads can quickly and effectively fail over from a site that has suffered a disaster to a surviving site relatively quickly. For example, the system deploys their applications on two geographically distant sites (i.e., a primary site and a DR site) to ensure that workloads can failover and recover from an affected primary on to the surviving DR site in case of a disaster.

Additionally, maintenance for the workloads is subject to strict cadence/windows to ensure that the availability of applications/workloads is not impacted. For example, maintenance is only allowed in certain predetermined windows and is expected to complete within a certain period of time. When maintenance completes, the system ensures that all software is synchronized across the entirety of the system. In addition, the system ensures that each availability zone is maintained separately and one of the availability zones is always available to service the workloads of the client. The system may also ensure that the DR site is kept updated in lock step and ahead of the primary site to ensure a safe and quick recovery in case of a disaster.

Moreover, the system provides a detailed audit trail to be maintained of the various operations that take place on the different availability zones across the primary and DR sites to comply with the strict regulatory requirements of these industries. This may include keeping a log of when each application instance, physical node, zone and site goes out for maintenance, finishes maintenance, among other operations.

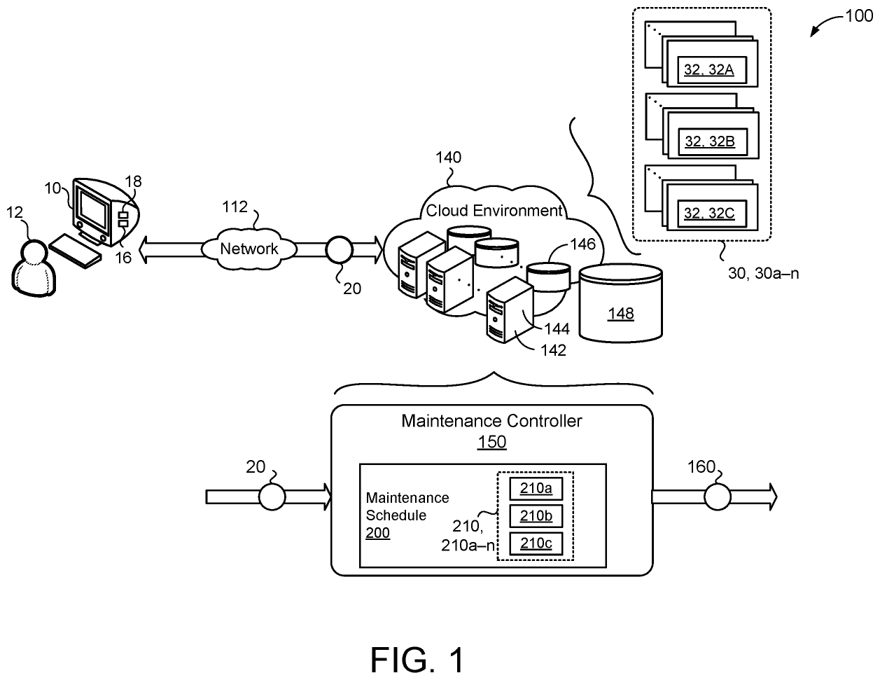

Referring now to FIG. 1, in some implementations, service maintenance system 100 includes a remote system 140 (also referred to herein as a public cloud environment) in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware).

The remote system 140 executes multiple services 30, 30a-n. A service 30 or software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications. Each service 30 is associated with a particular client 12 (or other entity). For example, the remote system 140 hosts a number of services 30 for the client 12 in a public cloud environment, offering the client 12 the scalability and other advantages of a distributed computing environment.

Each service 30 periodically requires maintenance. For example, a service 30 requires an update or other change that adds or maintains functionality. Generally, when performing maintenance on a service 30, the functionality of the service 30 is degraded or halted completely while the maintenance is performed. For example, the service 30 may become partially or totally unavailable during maintenance as the update is applied and/or tested. Each service 30 includes a criticality classification 32. The criticality classification 32 defines an amount of disruption maintenance of the corresponding service 30 causes. In some examples, the criticality classifications 32 include a critical classification 32, 32A; a semi-critical classification 32, 32B; and a non-critical classification 32, 32C. In other examples, additional or other criticality classifications 32 are included.

The critical classification 32A refers to a service 30 that causes a significant disruption to the client 12 or users of the client 12 when the service 30 experiences reduced functionality (e.g., from maintenance). The semi-critical classification 32B refers to a service that causes a minor or moderate disruption to the client 12 or users of the client 12 when the service experiences reduced functionality. The non-critical classification 32C refers to a service 30 that causes little to no disruption to the client 12 or users of the client 12 when the service 30 experiences reduced functionality. The client may define the criticality classifications 32 for each service. Additionally or alternatively, the maintenance controller 150 defines the criticality classifications 32 based on parameters of the service 30 (e.g., the reliance of other apps on the service 30, the amount of exposure of the service 30 to front-end users, a complexity of the service 30, etc.).

The remote system 140 executes a maintenance controller 150. The maintenance controller 150 obtains or receives or generates the criticality classifications 32 for the services 30 associated with the client 12. The maintenance controller 150 also obtains, receives, or generates a maintenance schedule 200. The maintenance schedule 200 defines a number of maintenance windows 210 for the services 30. Each maintenance window 210 is associated with a respective one of the criticality classifications 32. In some implementations, a first maintenance window 210a defines a period of time when services 30 with a critical classification 32A may undergo maintenance, a second maintenance window 210b defines a period of time when services 30 with a semi-critical classification 32B may undergo maintenance, and a third maintenance window 210c defines a period of time when services 30 with a non-critical classification 32C may undergo maintenance. There may be at least one maintenance window 210 for each criticality classification 32 assigned to the services 30 for the client 12.

The maintenance controller 150 receives a maintenance request 20 (e.g., via an application programming interface (API)) requesting maintenance for one of the services 30. The maintenance request 20 may originate from the client 12, from the service 30, or from any other application associated with the public cloud environment and/or the client 12. The maintenance controller 150, using the maintenance schedule 200, determines whether a maintenance window 210 associated with the criticality classification 32 of the service 30 is currently open. That is, the maintenance controller 150 determines if, at the current moment in time (i.e., when the request 20 is received or processed), is within the time window defined by the maintenance window 210 associated with the criticality classification 32 of the service 30 requesting maintenance.

In some examples, the maintenance controller 150 determines that each maintenance window 210 associated with the respective criticality classification 32 of the service 30 requesting maintenance is currently closed (i.e., the current time is outside the periods of time defined by the maintenance window(s) 210). In response to determining that the maintenance window 210 is currently closed, the maintenance controller 150 generates a maintenance response 160 that denies the maintenance request 20. The maintenance response 160 may be transmitted to the same entity that generated the maintenance request 20 (e.g., the client 12, the service 30, another application executing on the remote system 140, etc.). Based on the denial of the maintenance request 20, the service 30 will not begin maintenance at the current point in time. The maintenance request 20 may be retransmitted again at a later point in time when the maintenance window 210 may be open.

In other examples, the maintenance controller 150 determines that a maintenance window 210 that is associated with the criticality classification 32 of the requesting service 30 is currently open (i.e., the current point in time when the maintenance request 20 is received or processed is within the period of time defined by the maintenance window 210 associated with the criticality classification 32 associated with the service 30). In response to determining that the maintenance window 210 is currently open, the maintenance controller 150 may generate a maintenance response 160 that allows or permits the maintenance request 20. In this case, in response to the maintenance response 160, maintenance on the service 30 may begin.

The maintenance controller 150 may log or audit all maintenance requests 20 and maintenance responses 160. The maintenance controller 150 may also log maintenance start and completion times, along with any other relevant metadata for the maintenance and the associated service 30. The maintenance controller 150, in some examples, stores the logs or audits at the data store 148 for the client 12.

In some implementations, prior to allowing the maintenance request 20, the maintenance controller 150 determines whether the maintenance is estimated to be complete prior to the maintenance window 210. When the maintenance controller 150 determines that the maintenance is estimated to complete after the maintenance window 210 (e.g., the maintenance window 210 is open for 10 more hours, but the maintenance is estimated to take 15 hours to complete), the maintenance controller 150 may instead deny the maintenance request 20. However, in the event that the maintenance is estimated to be complete prior to the maintenance window 210 closing, the maintenance controller 150 may continue to allow the maintenance request 20. The maintenance controller 150 may estimate the amount of time to complete the maintenance based on an estimate included with the maintenance request 20, based on times for previous similar maintenance requests 20, based on predefined maintenance estimates, and/or based on other parameters available to the maintenance controller 150.

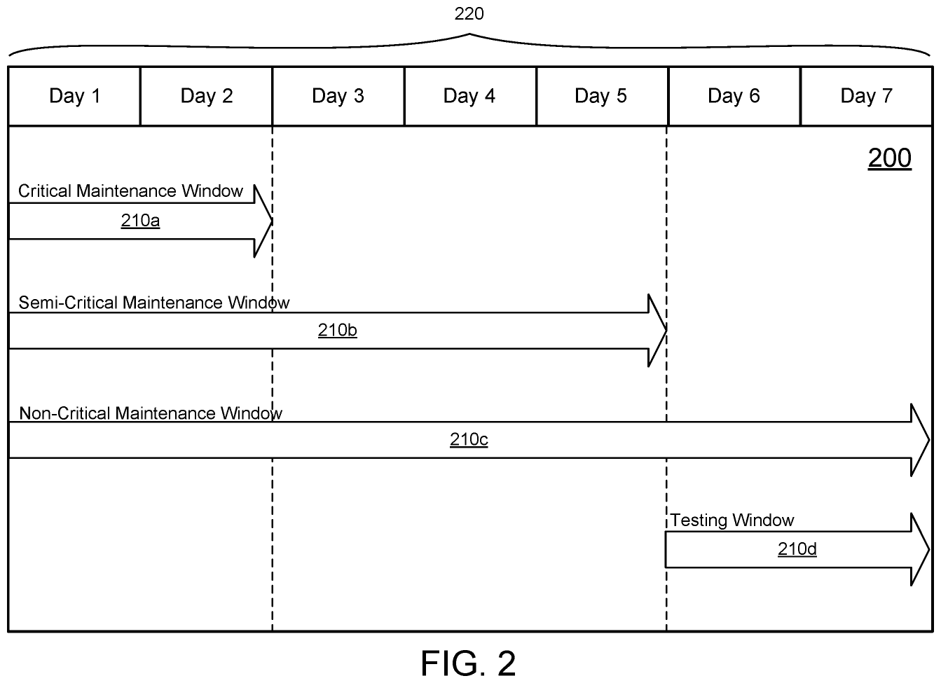

Referring now to FIG. 2, an exemplary maintenance schedule 200 includes a first maintenance window 210a that defines a period of time for services 30 with a critical classification 32A to undergo maintenance. The maintenance schedule 200 also includes a second maintenance window 210b that defines a period of time for services 30 with a semi-critical classification 32B to undergo maintenance and a third maintenance window 210c for services with a non-critical classification 32C to undergo maintenance. Here, the maintenance schedule 200 is a recurring maintenance schedule with a predefined period 220 of seven days. That is, the maintenance schedule recurs every seven days. The maintenance schedule 200 may have any appropriate period 220 (e.g., 1 day, 7 days, 10 days, 14 days, 30 days, etc.). The period 220 may be set by the client 12 or the remote system 140 depending upon the maintenance needs of the services 30 and/or the requirements of the client 12.

Continuing the example of FIG. 2, the first maintenance window 210a is open on the first day and the second day of each period 220. In contrast, the second maintenance window 210b is open for the first five days of the period 220. The third maintenance window 210c is open for the entire period 220. The maintenance schedule 200 may include additional or alternative maintenance windows 210. In this example, the maintenance schedule 200 includes a fourth maintenance window 210d for testing that is open during the last two days of the period 220. Here, if a service 30 with a semi-critical classification 32B requested maintenance that is estimated to take 2 days generates the maintenance request during Day 2, the maintenance controller 150 will allow the maintenance request 20, as the maintenance window 210b for the semi-critical classification 32B is open and the maintenance is estimated to complete before the maintenance window 210b closes. In contrast, if the maintenance request 20 is generated on Day 5, the maintenance request 20 may be denied because, although the maintenance window 210b is open, the maintenance is not estimated to be complete prior to the maintenance window 210b closing. The maintenance controller 150 will also deny the maintenance request 20 if received on Day 6, as the maintenance window 210b is closed.

As shown in the example of FIG. 2, the more critical the criticality classification, 32, the shorter and earlier in the period 220 the maintenance window 210 may be. This may be to ensure sufficient time to deploy and test the maintenance for critical services 30 before the period 220 ends. In some examples, the maintenance window 210c associated with the non-critical classification 32C is always open. Alternatively, the maintenance schedule 200 does not provide a maintenance window 210 for the non-critical classification 32C and instead services 30 with a non-critical classification 32C may perform maintenance without generating a maintenance request 20 at all (e.g., using an as-needed basis).

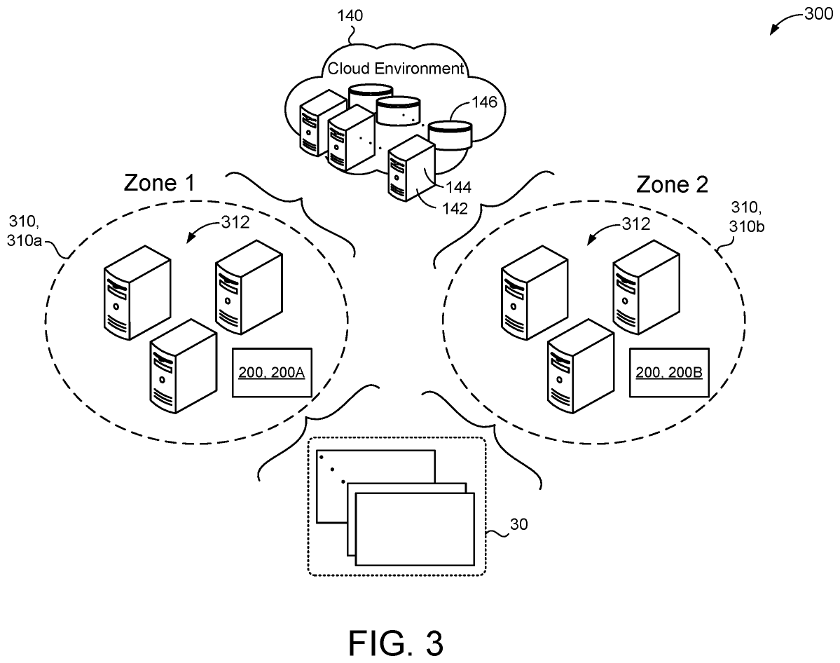

Referring now to FIG. 3, in some implementations, the remote system 140 includes multiple clusters 310, such as a first cluster 310, 310a and a second cluster 310, 310b. That is, each cluster 310 includes a portion of the distributed computing capabilities of the remote system 140 that are co-located within a similar geographic region. Each cluster includes one or more servers 312 or other computational resources that are geographically located relative to each other. For example, the first cluster 310a is associated with or located at a first geographic location and the second cluster 310b is associated with or located at a second geographic location that is different from the first geographic region. Each cluster 310 hosts the services 30. This provides the client 12 and the services 30 with redundant and geographically isolated hardware to ensure uptime even in the result of a disaster or other event that impacts functionality of one of the clusters 310. Each cluster is associated with a respective maintenance schedule 200. Here, the first cluster 310a (i.e., “Zone 1”) has a first maintenance schedule 200, 200A and the second cluster (i.e., “Zone 2”) has a second maintenance schedule 200, 200B.

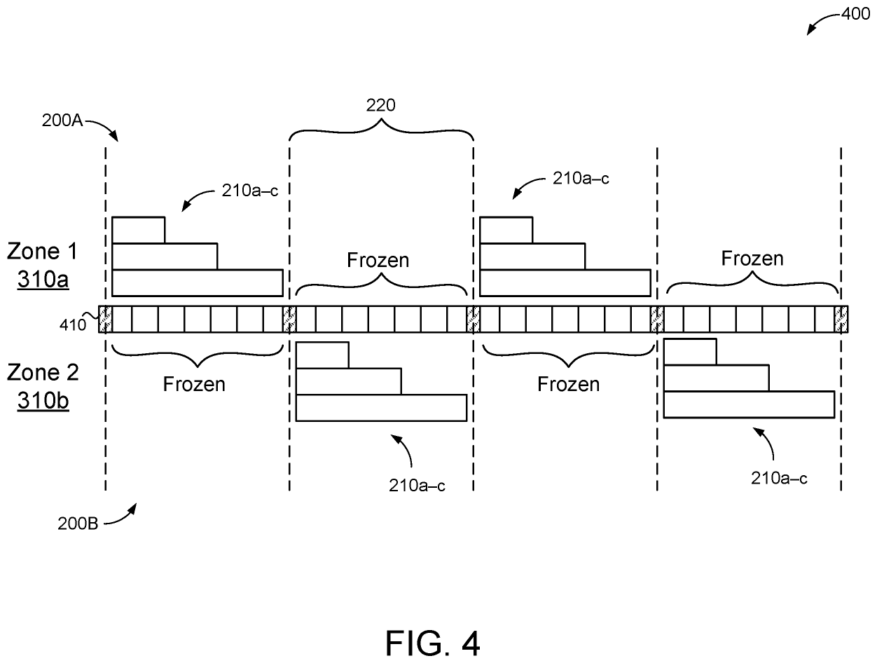

Referring now to FIG. 4, a schematic view 400 includes the exemplary first maintenance schedule 200A and second maintenance schedule 200B. In some implementations, when a first maintenance window 210 is open for the services 30 executing on the first cluster 310, each maintenance window 210 is closed for services 30 executing on the second cluster 310. That is, optionally, all maintenance windows 210 are “frozen” or closed always for at least one cluster 310. For example, when there are two clusters 310, one cluster 310 is “active” (i.e., the maintenance schedule 200 for that cluster 310 is active and in effect) and the other cluster is “frozen” (i.e., the maintenance schedule 200 is not in effect and all maintenance windows 210 are closed such that no maintenance can be performed). This ensures that there is always at least one cluster 310 that cannot be impacted by maintenance.

In the example of FIG. 4 where there are two clusters, the maintenance schedules 200 alternate activation/deactivation every period 220 (e.g., 7 days). Thus, when the maintenance schedule 200A is active and in effect for the first cluster 310a, the second cluster 310b is frozen. In contrast, when a maintenance window 210 is open for the services 30 executing on the second cluster 310b, each maintenance window 210 is closed for services 30 executing on the first cluster 310a.

In some implementations, each period 220 is bounded by a switchover period 410. During the switchover period 410 (e.g., one or two hours), neither maintenance schedule 200 is active and all maintenance windows 210 are closed. The switchover period 410 provides a buffer between the alternating activation/deactivation of the maintenance schedules 200 of the clusters 310. The length of the switchover period 410 may be configurable.

Thus, service maintenance system 100 provides a turn-key solution for clients 12 across different verticals. The system 100 may provide a set of consistent APIs to enable strict control over availability and maintenance for control that matches on-premises solutions while still benefiting from cloud scalability. The system 100 provides the ability to externalize a schedule of when disruptive activities (e.g., maintenance) may occur to allow the cloud provider explicit windows to perform the disruptive activities to manage the infrastructure. The system 100 allows the client 12 to offload non-disruptive maintenance completely to the cloud provider (i.e., non-critical maintenance). The system allows for automated, machine readable planned maintenance policies that may be customized or configured for different use cases and verticals. The system allows for easy replication via virtual machines (VMs), which is cheaper and faster than traditional bespoke arrangements. Additionally, the system allows for easy auditing and compliance verification via offering the ability to export/query audit logs and any other data.

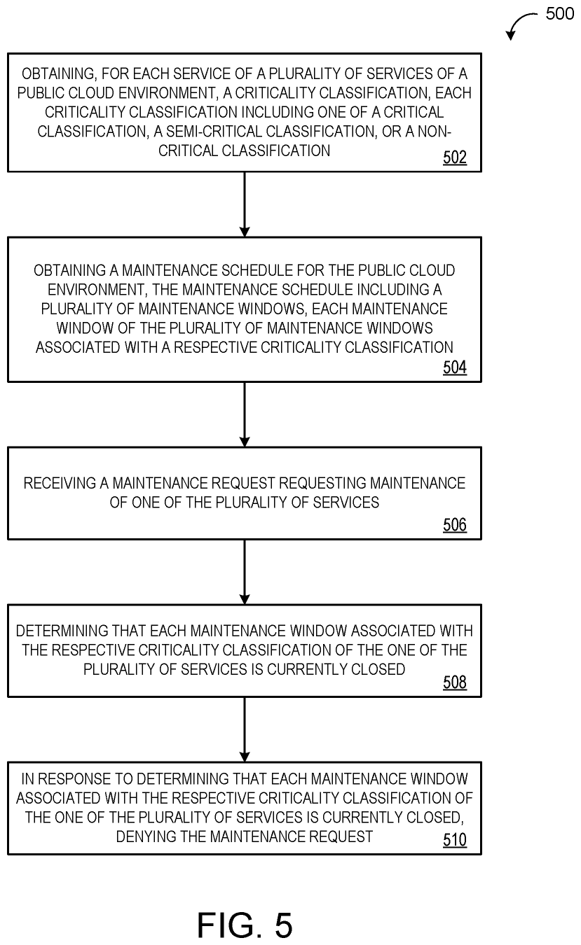

FIG. 5 is a flowchart of an exemplary arrangement of operations for a method 500 for a managed cloud offering for sensitive industry verticals. The computer-implemented method 500, when executed by data processing hardware 144, causes the data processing hardware 144 to perform operations. The method 500, at operation 502, includes obtaining, for each service 30 of a plurality of services 30 of a public cloud environment 140, a criticality classification 32. Each criticality classification 32 includes one of a critical classification 32A, a semi-critical classification 32B, or a non-critical classification 32C. The method 500, at operation 504, includes obtaining a maintenance schedule 200 for the public cloud environment 140. The maintenance schedule 200 includes a plurality of maintenance windows 210 and each maintenance window 210 of the plurality of maintenance windows 210 is associated with a respective criticality classification 32. At operation 506, the method 500 includes receiving a maintenance request 20 requesting maintenance of one of the plurality of services 30. The method 500, at operation 508, includes determining that each maintenance window 210 associated with the respective criticality classification 32 of the one of the plurality of services 30 is currently closed. In response to determining that each maintenance window 210 associated with the respective criticality classification 32 of the one of the plurality of services 30 is currently closed, the method 500, at operation 510, includes denying the maintenance request 20.

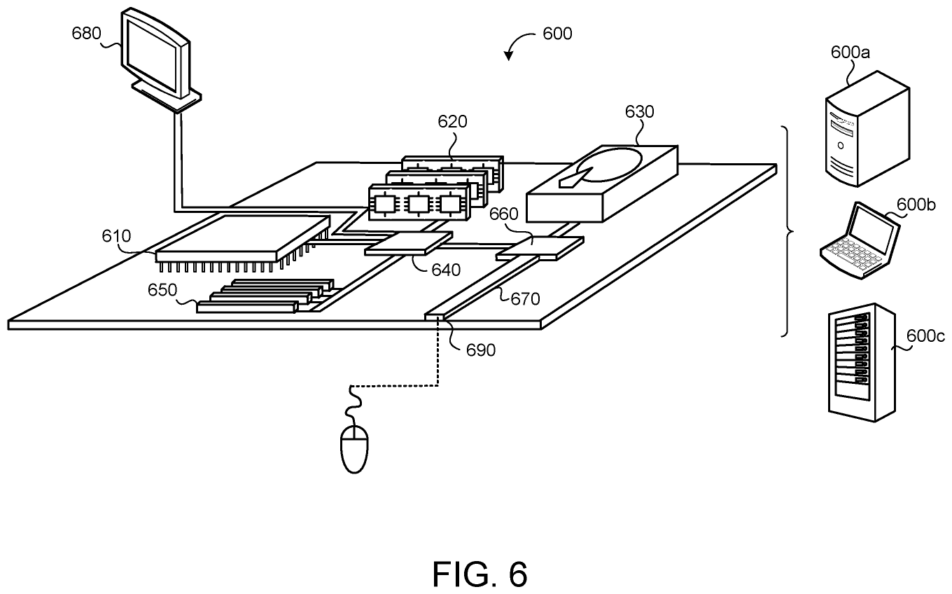

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
obtaining, for each service of a plurality of services of a public cloud environment, a criticality classification, each criticality classification comprising one of:
a critical classification;
a semi-critical classification; or
a non-critical classification;
obtaining a maintenance schedule for the public cloud environment, the maintenance schedule comprising a plurality of maintenance windows, each maintenance window of the plurality of maintenance windows associated with a respective criticality classification;
receiving a maintenance request requesting maintenance of one of the plurality of services;
determining that each maintenance window associated with the respective criticality classification of the one of the plurality of services is currently closed; and
in response to determining that each maintenance window associated with the respective criticality classification of the one of the plurality of services is currently closed, denying the maintenance request.

2. The method of claim 1, wherein the operations further comprise:
receiving a second maintenance request requesting maintenance of the one of the plurality of services;
determining that one maintenance window associated with the respective criticality classification of the one of the plurality of services is currently open; and
based on determining that the one maintenance window associated with the respective criticality classification of the one of the plurality of services is currently open, allowing the maintenance request.

3. The method of claim 2, wherein:
the operations further comprise determining that maintenance defined by the maintenance request will complete prior to the one maintenance window associated with the respective criticality classification of the one of the plurality of services closes; and
allowing the maintenance request is further based on determining that the maintenance defined by the maintenance request will complete prior to the one maintenance window associated with the respective criticality classification of the one of the plurality of services closes.

4. The method of claim 1, wherein:
the public cloud environment comprises a first cluster and a second cluster; and
the plurality of services execute within the first cluster or the second cluster.

5. The method of claim 4, wherein:
the first cluster is associated with a first geographic region;
the second cluster is associated with a second geographic region; and
the first geographic region and the second geographic region are different.

6. The method of claim 4, wherein, when a first maintenance window of the plurality of maintenance windows is open for the plurality of services executing on the first cluster, each maintenance window of the plurality of maintenance windows is closed for services executing on the second cluster.

7. The method of claim 6, wherein, when a second maintenance window of the plurality of maintenance windows is open for the plurality of services executing on the second cluster, each maintenance window of the plurality of maintenance windows is closed for services executing on the first cluster.

8. The method of claim 4, wherein the plurality of maintenance windows alternates opening and closing between the first cluster and the second cluster.

9. The method of claim 1, wherein any maintenance window associated with the non-critical classification is always open.

10. The method of claim 1, wherein the maintenance schedule comprises a recurring maintenance schedule with a predefined period.

11. A system comprising:
data processing hardware; and
memory hardware in communication with the data processing hardware, the memory hardware storing instructions that when executed on the data processing hardware cause the data processing hardware to perform operations comprising:
obtaining, for each service of a plurality of services of a public cloud environment, a criticality classification, each criticality classification comprising one of:
a critical classification;
a semi-critical classification; or
a non-critical classification;
obtaining a maintenance schedule for the public cloud environment, the maintenance schedule comprising a plurality of maintenance windows, each maintenance window of the plurality of maintenance windows associated with a respective criticality classification;
receiving a maintenance request requesting maintenance of one of the plurality of services;
determining that each maintenance window associated with the respective criticality classification of the one of the plurality of services is currently closed; and
in response to determining that each maintenance window associated with the respective criticality classification of the one of the plurality of services is currently closed, denying the maintenance request.

12. The system of claim 11, wherein the operations further comprise:
receiving a second maintenance request requesting maintenance of the one of the plurality of services;
determining that one maintenance window associated with the respective criticality classification of the one of the plurality of services is currently open; and
based on determining that the one maintenance window associated with the respective criticality classification of the one of the plurality of services is currently open, allowing the maintenance request.

13. The system of claim 12, wherein:
the operations further comprise determining that maintenance defined by the maintenance request will complete prior to the one maintenance window associated with the respective criticality classification of the one of the plurality of services closes; and
allowing the maintenance request is further based on determining that the maintenance defined by the maintenance request will complete prior to the one maintenance window associated with the respective criticality classification of the one of the plurality of services closes.

14. The system of claim 11, wherein:
the public cloud environment comprises a first cluster and a second cluster; and
the plurality of services execute within the first cluster or the second cluster.

15. The system of claim 14, wherein:
the first cluster is associated with a first geographic region;
the second cluster is associated with a second geographic region; and
the first geographic region and the second geographic region are different.

16. The system of claim 14, wherein, when a first maintenance window of the plurality of maintenance windows is open for the plurality of services executing on the first cluster, each maintenance window of the plurality of maintenance windows is closed for services executing on the second cluster.

17. The system of claim 16, wherein, when a second maintenance window of the plurality of maintenance windows is open for the plurality of services executing on the second cluster, each maintenance window of the plurality of maintenance windows is closed for services executing on the first cluster.

18. The system of claim 14, wherein the plurality of maintenance windows alternates opening and closing between the first cluster and the second cluster.

19. The system of claim 11, wherein any maintenance window associated with the non-critical classification is always open.

20. The system of claim 11, wherein the maintenance schedule comprises a recurring maintenance schedule with a predefined period.
